(19) United States
(12) Patent Application Publication
(10) Pub. No.: US 2026/0253287 A1
(43) Pub. Date: Aug. 27, 2026

(54) METHOD, APPARATUS, DEVICE AND STORAGE MEDIUM FOR MEDIA ASSET GENERATION

(71) Applicants: Lemon Inc., Grand Cayman (KY); Beijing Zitiao Network Technology Co., Ltd., Beijing (CN)

(72) Inventors: Long JIANG, Culver City, CA (US); Runze ZHANG, Los Angeles, CA (US); Shiyuan LIU, Beijing (CN); Minqi LUO, Culver City, CA (US)

(21) Appl. No.: 19/550,019

(22) Filed: Feb. 25, 2026

(30) Foreign Application Priority Data
Feb. 25, 2025 (WO) PCT/CN2025/079071

(51) Int. Cl. G06T 11/60

(52) U.S. Cl. CPC G06T 11/60; G06T 2200/24

(57) ABSTRACT

According to embodiments of the disclosure, a method and apparatus for media asset generation are provided. The method includes: presenting a media asset generation interface in response to a predetermined operation received in a media editing interface, the media asset generation interface comprising a canvas component; presenting, in the canvas component, a graphical content corresponding to a first interaction operation in response to the first interaction operation received via the canvas component; presenting, in a preview component of the media editing interface, a first media asset generated based on the graphical content; and adding, in response to a second interaction operation received via the media asset generation interface, a target media asset determined based on the first media asset to the media editing interface. In this way, the embodiments of the disclosure can effectively improve media asset generation efficiency.

### CROSS-REFERENCE

This application claims priority to International Application No. PCT/CN2025/079071, filed on February 25, 2025 and entitled ‘METHOD, APPARATUS, DEVICE AND STORAGE MEDIUM FOR MEDIA ASSET GENERATION’, which is incorporated herein by reference in its entirety.

### FIELD

Example embodiments of the present disclosure generally relate to the field of computers, and in particular, to a method, apparatus, device and computer-readable storage medium for media asset generation.

### BACKGROUND

With the development of Internet technology, the demand for image editing is gradually increased, and the generation and editing of media assets is an important part in image editing. The media asset generation technology can quickly generate diversified media assets according to requirements of users, which provides an intelligent media asset generation channel for users.

### SUMMARY

In a first aspect of the present disclosure, a method for media asset generation is provided. The method includes: presenting a media asset generation interface in response to a predetermined operation received in a media editing interface, the media asset generation interface including a canvas component; presenting, in the canvas component, a graphical content corresponding to a first interaction operation in response to the first interaction operation received via the canvas component; presenting, in a preview component of the media editing interface, a first media asset generated based on the graphical content; and adding, in response to a second interaction operation received via the media asset generation interface, a target media asset determined based on the first media asset to the media editing interface.

In a second aspect of the present disclosure, an apparatus for media asset generation is provided. The apparatus includes: a first presenting module configured to present a media asset generation interface in response to a predetermined operation received in a media editing interface, the media asset generation interface including a canvas component; a second presenting module configured to present, in the canvas component, a graphical content corresponding to a first interaction operation in response to the first interaction operation received via the canvas component; a third presenting module configured to present, in a preview component of the media editing interface, a first media asset generated based on the graphical content; and an adding module configured to add, in response to a second interaction operation received via the media asset generation interface, a target media asset determined based on the first media asset to the media editing interface.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments according to the present disclosure may be implemented;

FIGS. 2A-2E illustrate example interfaces for media asset generation according to some embodiments of the present disclosure;

FIG. 3 illustrates a flowchart of an example process of media asset generation according to some embodiments of the disclosure;

FIG. 4 illustrates a schematic structural block diagram of an example apparatus for media asset generation according to some embodiments of the present disclosure; and

FIG. 5 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are illustrated in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

As mentioned above, with the development of Internet technology, the demand for image editing is gradually increasing, and the generation and editing of media assets is an important part of image editing. Media asset generation technology can quickly generate diversified media assets according to the needs of users, which provides users with a diversified, intelligent media asset generation channels.

The embodiment of the present disclosure provides a media asset generation scheme. The scheme includes: presenting a media asset generation interface in response to a predetermined operation received in a media editing interface, the media asset generation interface including a canvas component; presenting, in the canvas component, a graphical content corresponding to a first interaction operation in response to the first interaction operation received via the canvas component; presenting, in a preview component of the media editing interface, a first media asset generated based on the graphical content; and adding, in response to a second interaction operation received via the media asset generation interface, a target media asset determined based on the first media asset to the media editing interface.

In this way, the embodiments of the present disclosure may generate the target media asset through the graphic content corresponding to the first interaction operation, which can effectively reduce the steps required to generate the target media asset, thereby effectively improving the media asset generation efficiency. In addition, the embodiment of the present disclosure presents the preview component in the canvas component, so that the user can more intuitively view the generated media asset through the preview component, thereby improving the interaction experience of the user.

Various example implementations of this scheme are described in detail below in conjunction with the accompanying drawings.

### Example Environment

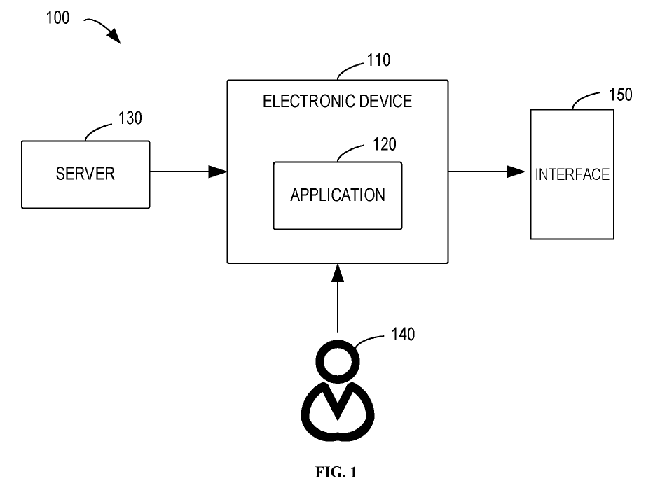

FIG. 1 illustrates a schematic diagram of an example environment 100 in which embodiments of the present disclosure may be implemented. As illustrated in FIG. 1, the example environment 100 may include an electronic device 110.

In this example environment 100, the electronic device 110 may run an application 120 that supports media asset generation. The application 120 may be any suitable type of application for media asset generation, examples of which may include, but are not limited to: a social application, a content sharing application, an image editing application, or a further suitable application. A user 140 may interact with the application 120 via the electronic device 110 and/or its attachment device.

In the environment 100 of FIG. 1, if the application 120 is in an active state, the electronic device 110 may present, via the application 120, an interface 150 for supporting media asset generation.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, or may be a server cluster or a distributed system composed of a plurality of physical servers, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms. The server 130 may include, for example, a computing system/server, such as a mainframe, an edge computing node, a computing device in a cloud environment, or the like. The server 130 may provide background services for applications 120 that support media asset generation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection therebetween.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

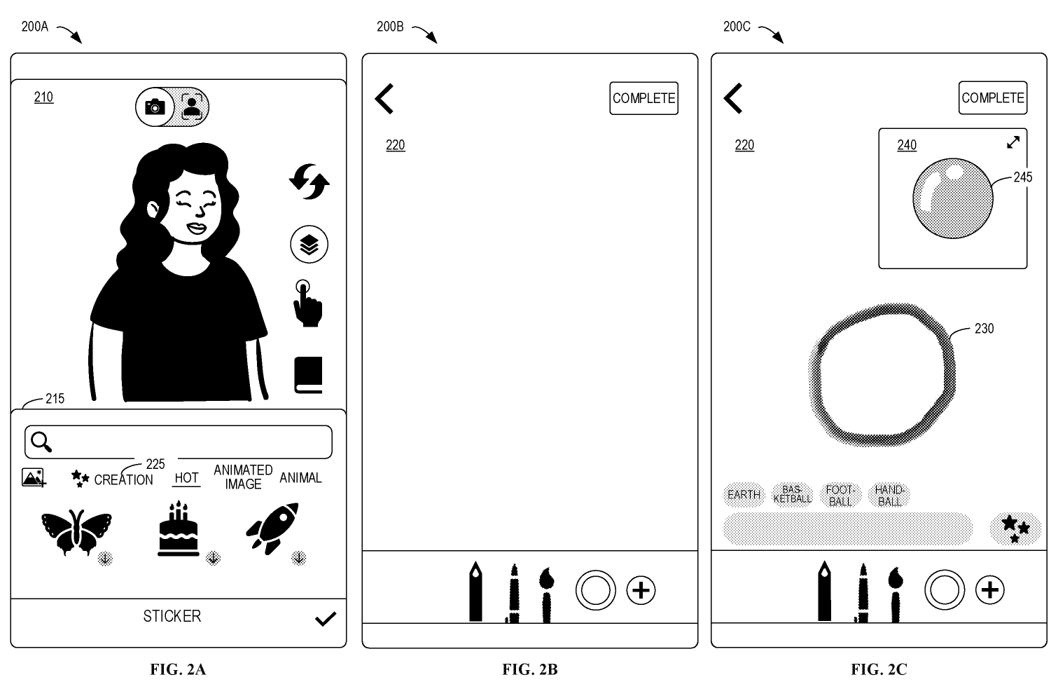

FIGS. 2A-2E illustrate example interfaces 200A- 200E, in accordance with some embodiments of the present disclosure. The interface 200A to the interface 200E may be provided, for example, by the electronic device 110 shown in FIG. 1.

In some embodiments, after receiving a media editing request, the electronic device 110 may present a media editing interface. Such media editing request may be a selection of an editing control associated with a target media content by the user 140, which may be, for example, an image content or a video content. The media editing interface includes a media asset selection panel.

As an example, as shown in FIG. 2A, after the electronic device 110 receives the media editing request, the interface 200A may be presented. The interface 200A may be, for example, a media editing interface. The interface 200A includes a media editing panel 210, and the media editing panel 210 includes a media content to be edited. The media content to be edited 210 may be, for example, a photo or a video uploaded by the user 140. In some scenarios, the electronic device 110 may further receive a capturing request of the user to perform a capturing task. After the capturing task is completed, the electronic device 110 may present a photo captured by the electronic device 110 in the media editing panel 210 to use the photo as the media content to be edited 210.

After the electronic device 110 presents the interface 200A, the electronic device 110 may also provide a media asset selection panel 215 in the interface 200A. The media asset selection panel 215 includes a plurality of media assets, and the plurality of media assets may be predetermined media assets or media assets previously generated by the electronic device 110. The electronic device 110 may also present a plurality of selection controls in the media asset selection panel 215, the plurality of selection controls being associated with different types of media assets. The type of media asset may include, for example, a “hot” type, an animal type, a food type, and the like. The “hot” type herein indicates that the media asset under this type is a set of media assets that have been used more than a threshold number of times during a predetermined time period. In this way, the electronic device 110 may provide various interaction elements to the user 140, thereby enriching the interaction effect of media editing.

In some scenarios, the electronic device 110 may receive a selection of a target sticker by a user via the media asset selection panel 215 to add a target sticker to the media content to be edited 210.

In some embodiments, the electronic device 110 presents a media asset generation interface in response to a predetermined operation received in a media editing interface, the media asset generation interface including a canvas component. As an example, as shown in FIG. 2A, the electronic device 110 may accept a predetermined operation of the user 140 via the interface 200A. Such predetermined operation may be, for example, a long-press operation of the media content 210 by the user 140, a sliding operation, a selection operation on a predetermined control in the interface 200A, or a further appropriate operation. After the electronic device 110 receives the predetermined operation via the interface 200A, the electronic device 110 may present the interface 200B shown in FIG. 2B, and the interface 200B may be, for example, a media asset generation interface. The interface 200B may be configured to receive an interaction operation of a user to present a media asset generated based on the interaction operation.

In some scenarios, the electronic device 110 may also present a canvas component 220 in the interface 200B. The electronic device 110 may receive an interaction operation of the user through the canvas component 220, such an interaction operation may be, for example, a drawing operation.

In some embodiments, the electronic device 110 may provide a media asset generation entry in the media asset selection panel 215. The electronic device 110 may present the media asset generation interface in response to the media asset generation entry being selected.

As an example, as shown in FIG. 2A, the electronic device 110 may provide a media asset generation entry 225 in the media asset selection panel 215. After the media asset generation entry 225 is selected by the user 140, the electronic device 110 may present the media asset generation interface shown in FIG. 2B.

In some embodiments, the electronic device 110 presents, in the canvas component, a graphical content corresponding to a first interaction operation in response to the first interaction operation received via the canvas component. As an example, as shown in FIG. 2C, the electronic device 110 may obtain the first interaction operation of the user via the canvas component 220, and the first interaction operation may be, for example, a drawing operation. After the drawing operation of the user is obtained, the electronic device 110 may present a graphical content 230 corresponding to the drawing operation in the canvas component 220.

In some scenarios, the electronic device 110 may also provide a set of brush tools in the canvas component 220. After receiving a selection of a target brush tool by the user 140, the electronic device 110 may provide a painting effect corresponding to the target brush tool to the user 140.

In some embodiments, the electronic device 110 presents, in a preview component of media editing, a first media asset generated based on the graphical content. As an example, as shown in FIG. 2C, after presenting the graphical content 230, the electronic device 110 may present a preview component 240 in the canvas component 220. The preview component 240 allows the user 140 to view a rendering effect of the media asset when the media asset is not determined. In some scenarios, the electronic device 110 may present a first media asset 245 in real time via the preview component 240 in a drawing process of the user 140, and the first media asset 245 is generated based on at least the graphic content 230. According to the embodiment of the present disclosure, the first media asset can be presented in the drawing process of the user 140 through the preview component 240, so that the user 140 can view a rendering effect of the first media asset in time, so that the user may modify the graphic content 230 based on the rendering effect. In this way, the embodiments of the present disclosure can effectively improve the interaction experience of the user 140, and can improve the efficiency of media asset generation.

In some scenarios, as shown in FIG. 2D, the electronic device 110 may also receive an additional interaction operation of the user 140, which may be, for example, a continuous drawing operation of the user 140 or a modification operation for the graphical content 230 (e.g., modifying a shape, color, size, etc. of the graphical content 230). Further, the electronic device 110 may present the graphical content 235 in the canvas component 220 and present an adjusted first media asset 250 in the preview component 240.

In some embodiments, the electronic device 110 may obtain second input information. As an example, as shown in FIG. 2D, the electronic device 110 may obtain the second input information of the user 140 via the canvas component 220. Such second input information may be used, for example, to generate the first media asset 250 with the graphical content 235.

In some embodiments, the electronic device 110 may obtain a second description text via a second input control in the canvas component. As an example, as shown in FIG. 2D, the electronic device 110 may present a second input control 255 in the canvas component 220. The second input control 255 is configured to receive an input operation of a user. After the user 140 performs the input operation on the second input control 255, the electronic device 110 may obtain a second description text corresponding to the input operation via the second input control 255. In this way, the electronic device 110 may provide the first media asset 250 to the user 140 based on the description information input by the user 140, thereby enriching the generation pattern of the media asset and improving the effect of media asset generation.

In some embodiments, the electronic device 110 may receive a selection of at least one of the second set of candidate items presented in the canvas component. As an example, as shown in FIG. 2D, the electronic device 110 may present a second set of candidate items 260 in the canvas component 220. The electronic device 110 may receive a selection of the second candidate by the user via the second set of candidates 260 to generate the first media asset 250 the second candidate and the graphical content 235. The second set of candidate items 260 herein may be determined by the generation model based on the graphical content 235. For example, if the graphic content 235 is circular, the second set of candidate items 260 may be “earth”, “football”, “board ball”, “three-dimension”, “two-dimension”, or the like. The generation model herein may be used to generate a machine learning method with a particular graph structure. Graph structural features such as node connection mode, degree distribution and vergence coefficient in real graph data are learned, so that a random map similar to real graph data may be constructed. The generation model may be any suitable generation model such as generation adversarial network model, variational autoencoder, diffusion model, or the like.

In some embodiments, after the electronic device 110 obtains the second input information, the first media asset determined based on the second input information and the graphical content may be presented in the preview component. As an example, as shown in FIG. 2D, after receiving the second input information, the electronic device 110 may present the first media asset 250 in the preview component 240. The first media asset 250 may be generated by the generation model based on the graphical content 235 and the second input information. The graphic content 235 may be, for example, a graphic of “smiley face”, and the second input information may be, for example, “columnar”.

In some embodiments, after the first media asset is presented, the electronic device 110 may further obtain, via the preview component, adjustment information (for example, the first input information) of the user 140 for the first media asset, so as to present a target media asset in the preview component. The target media asset herein may be generated by the generation model based on the first input information and the first media asset. Specifically, the electronic device 110 may obtain the first input information. As an example, as shown in FIG. 2E, the electronic device 110 may receive a selection operation of the user 140 for the preview component 240, and present the preview component 240 in the interface 200E in a predetermined proportion. Further, the electronic device 110 may obtain the first input information via the preview component 240, such that the first input information may be used, for example, to generate the target media asset with the first media asset 250.

In some embodiments, the electronic device 110 may obtain a first description text via a first input control in the preview component. The target media asset includes a second media asset generated by a generation model based on the first description text and the first media asset.

As an example, the electronic device 110 may provide a first input control 265 in the preview component 240. The electronic device may obtain the first description text through the first input control 265 to present a second media asset in the preview component 240. The second media asset herein may be, for example, generated by the generation model based on the first descriptive text and the first media asset 250.

In a further embodiment, the electronic device 110 may receive a selection of at least one first candidate item in a first set of candidate items presented in the preview component. The target media asset includes a third media asset generated by a generation model based on the first media asset and a predetermined prompt corresponding to the at least one first candidate item.

As an example, as shown in FIG. 2E, the electronic device 110 may further provide a first set of candidate items 270 in the preview component 240. The electronic device 110 may present the first set of candidates 270 in the preview component 240. The electronic device 110 may receive a selection of a first candidate item by the user via the first set of candidate items 270 to obtain the first input information. The first set of candidate items 270 herein may be determined by the generation model based on the first media asset 250.

Further, after the first input information is obtained by the electronic device 110, the electronic device 110 may present, in the preview component, the target media asset determined based on the first input information and the first media asset. As an example, after the first input information is obtained by the electronic device 110, the electronic device 110 may send the first input information and the first media asset 250 to the server 130, to generate the target media asset through the generation model in the server 130. After the target media asset is generated, the electronic device 110 may request to obtain the target media asset from the server 130 to present the target media asset in the preview component 240. In this way, the electronic device 110 may provide the target media asset to the user 140 based on the input information of the user 140, so that the media asset generation process may be simplified, and the media asset generation efficiency is improved.

In some embodiments, the electronic device 110 may receive, via the preview component, an editing operation for the first media asset to determine the target media asset. As an example, the electronic device 110 may further receive, through the preview component 240, an editing operation performed by the user 140 on the first media asset. Such editing operation may be, for example, adjusting the structure or color of the first media asset 250. For example, the first media asset 250 is adjusted from a circle to a square, or the first media asset 250 is adjusted from blue to red. After receiving the editing operation performed by the user 140 on the first media asset, the electronic device 110 may determine the target media asset based on the editing operation.

In some embodiments, the electronic device 110 may also present an indication element in the preview component 240. As shown in FIG. 2E, the electronic device 110 may provide, in the preview component 240, an indication element 275 indicating that the presentation effect of the media asset in the preview component 240 is allowed to be adjusted. Further, the electronic device 110 may receive an adjustment operation for the target media asset by the user 140 through the preview component 240. Such adjustment operation may include, for example: adjusting a presentation angle of the target media asset, adjusting a relative position of the target media asset in the preview component, adjusting a perspective effect of the target media asset, and the like. The perspective effect refers to a method and a visual effect of reproducing a space feeling and a stereoscopic feeling of an object on a screen.

In some embodiments, the electronic device 110 adds the target media asset determined based on the first media asset to the media editing interface in response to the second interaction operation received via the media asset generation interface. As an example, as shown in FIG. 2D, the electronic device 110 may provide a determination control 280 in the canvas component. The electronic device 110 may receive a second interaction operation of the user 140 via the determination control 280, for example, may be a selection operation of the user 140 on the determination control 280. After the second interaction operation is selected, the electronic device 110 may add the target media asset to the interface 200A (that is, the media editing interface), where the target media asset herein may be the first media asset, or may be a further media asset generated by the first media asset.

In some scenarios, after receiving the second interaction operation, the electronic device 110 may present an additional component associated with the target media asset. For example, the additional component may include a posting control. The second interaction operation herein may be, for example, a long-press operation on the target media asset. After presenting the additional component, the electronic device 110 may obtain a selection of the posting by the user via the additional component, and add the target media asset to the media editing interface in response to selection of the additional control.

In this way, the embodiments of the present disclosure can generate the corresponding media asset through the graphic content, thereby reducing the interaction operation required for generating the media asset and improving the efficiency of media asset generation.

In some embodiments, the electronic device 110 may add the target media asset to the media editing panel 210 or the media asset selection panel 215. Specifically, the electronic device 110 may add, in response to the second interaction operation received via the media asset generation interface, the target media asset to the media editing panel and/or the media asset selection panel.

As an example, the electronic device 110 may present a collection control in the additional component after presenting the additional component. The electronic device 110 may receive a second interaction operation of the user 140 (the second interaction operation herein may be, for example, a selection of a collection control), and add the target media asset to the media asset selection panel 215.

As a further example, the electronic device 110 may receive the second interaction operation of the user 140 by the determination control 280, such second interaction operation may be, for example, a selection of the determination control 280. After the determination control 280 is selected, the electronic device 110 may add the target media asset to the media editing panel 210.

In this way, the embodiments of the present disclosure can generate a target media asset through a graphic content corresponding to a first interaction operation, which can greatly reduce the steps required to generate the target media asset, thereby effectively improving the media asset generation efficiency. In addition, the embodiment of the present disclosure presents a preview component in a canvas component, so that the user can more intuitively view the generated media asset through the preview component, thereby improving the interaction experience of the user.

### Example Process

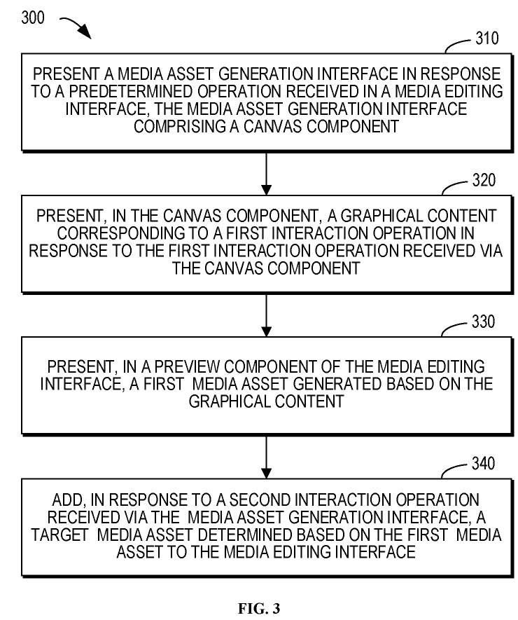

FIG. 4 illustrates a flowchart of an example process 300 for media asset generation according to some embodiments of the present disclosure. Process 300 may be implemented at electronic device 110. The process 300 is described below with reference to FIG. 1.

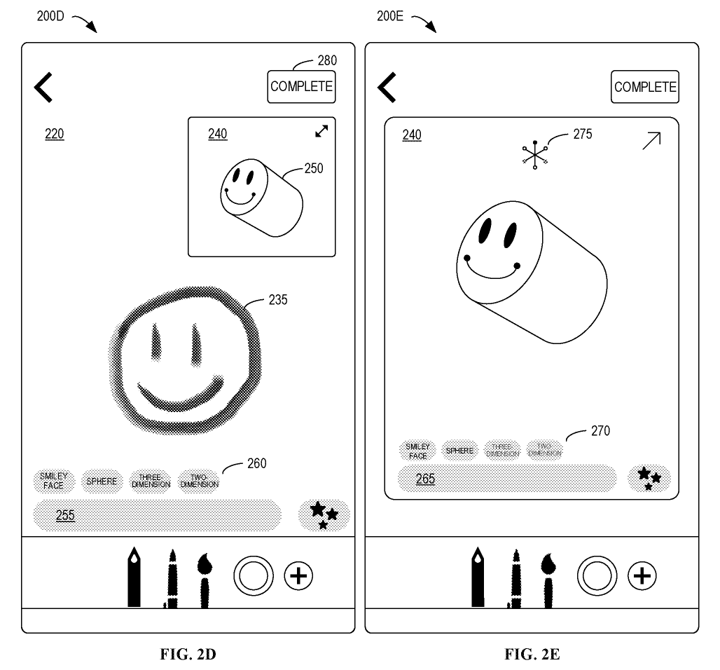

As shown in FIG. 3, in block 310, the electronic device 110 presents a media asset generation interface in response to a predetermined operation received in a media editing interface, the media asset generation interface including a canvas component.

At block 320, the electronic device 110 presents , in the canvas component, a graphical content corresponding to a first interaction operation in response to the first interaction operation received via the canvas component.

At block 330, the electronic device 110 presents, in a preview component of the media editing interface, a first media asset generated based on the graphical content.

At block 340, the electronic device 110 adds, in response to a second interaction operation received via the media asset generation interface, a target media asset determined based on the first media asset to the media editing interface.

In some embodiments, the process 300 further includes: obtaining first input information; and presenting, in the preview component, the target media asset determined based on the first input information and the first media asset.

In some embodiments, obtaining the first input information via the preview component includes: obtaining a first description text via a first input control in the preview component, where the target media asset includes a second media asset generated by a generation model based on the first description text and the first media asset.

In some embodiments, obtaining the first input information via the preview component includes: receiving a selection of at least one first candidate item in a first set of candidate items presented in the preview component, where the target media asset includes a third media asset generated by a generation model based on the first media asset and a predetermined prompt corresponding to the at least one first candidate item.

In some embodiments, presenting, in the preview component of the media editing interface, the first media asset generated based on the graphical content includes: obtaining second input information; and presenting, in the preview component, the first media asset determined based on the second input information and the graphical content.

In some embodiments, obtaining the second input information via the canvas component includes: obtaining a second description text via a second input control in the canvas component.

In some embodiments, obtaining the second input information via the canvas component includes: receiving a selection of at least one of the second set of candidate items presented in the canvas component.

In some embodiments, the process 300 further includes: receiving, via the preview component, an editing operation for the first media asset to determine the target media asset.

In some embodiments, the media editing interface includes a media editing panel and a media asset selection panel, the media asset selection panel includes a media asset generation entry, and presenting the media asset generation interface in response to the predetermined operation received in the media editing interface includes: presenting the media asset generation interface in response to the media asset generation entry being selected.

In some embodiments, adding the target media asset determined based on the first media asset to the media editing interface includes: adding, in response to the second interaction operation received via the media asset generation interface, the target media asset to the media editing panel and/or the media asset selection panel in the media editing interface.

### Example Apparatus and Device

Embodiments of the present disclosure also provide a corresponding apparatus for implementing the above method or process. FIG. 4 illustrates a schematic structural block diagram of an example apparatus 400 for media asset generation according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: a first presenting module 410 configured to present a media asset generation interface in response to a predetermined operation received in a media editing interface, the media asset generation interface including a canvas component; a second presenting module 420 configured to present, in the canvas component, a graphical content corresponding to a first interaction operation in response to the first interaction operation received via the canvas component; a third presenting module 430 configured to present, in a preview component of the media editing interface, a first media asset generated based on the graphical content; and an adding module 440 configured to add, in response to a second interaction operation received via the media asset generation interface, a target media asset determined based on the first media asset to the media editing interface.

In some embodiments, the apparatus 400 further includes a first obtaining module configured to obtain first input information; and present, in the preview component, the target media asset determined based on the first input information and the first media asset.

In some embodiments, the first obtaining module is further configured to: obtain a first description text via a first input control in the preview component, where the target media asset includes a second media asset generated by a generation model based on the first description text and the first media asset.

In some embodiments, the obtaining module is further configured to: receive a selection of at least one first candidate item in a first set of candidate items presented in the preview component, where the target media asset includes a third media asset generated by a generation model based on the first media asset and a predetermined prompt corresponding to the at least one first candidate item.

In some embodiments, the third presenting module 430 is further configured to: obtain second input information; and present, in the preview component, the first media asset determined based on the second input information and the graphical content.

In some embodiments, the third presenting module 430 is further configured to obtain a second description text via a second input control in the canvas component.

In some embodiments, the third presenting module 430 is further configured to receive a selection of at least one of the second set of candidate items presented in the canvas component.

In some embodiments, the apparatus 400 further includes a receiving module configured to receive, via the preview component, an editing operation for the first media asset to determine the target media asset.

In some embodiments, the media editing interface includes a media editing panel and a media asset selection panel, the media asset selection panel includes a media asset generation entry. The first presenting module is further configured to present the media asset generation interface in response to the media asset generation entry being selected.

In some embodiments, the adding module is further configured to add, in response to the second interaction operation received via the media asset generation interface, the target media asset to the media editing panel and/or the media asset selection panel in the media editing interface.

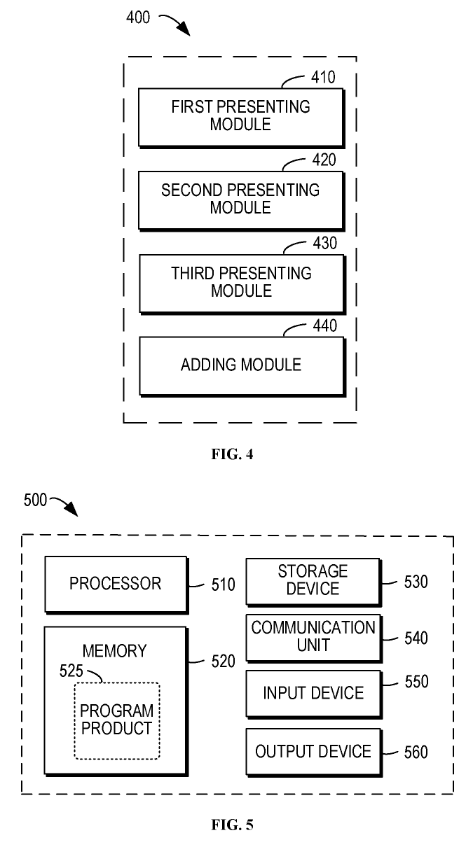

As shown in FIG. 5, the electronic device 500 is in a form of a general-purpose electronic device. Components of the electronic device 500 may include, but are not limited to, one or more processors or processing units 510, memory 520, storage device 530, one or more communication units 540, one or more input devices 550, and one or more output devices 560.The processor 510 may be an actual or virtual processor and is capable of performing various processes based on programs stored in the memory 520. In a multiprocessor system, a plurality of processors performs computer-executable instructions in parallel to improve the parallel processing capability of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a disk, or any other medium that may be capable of storing information and/or data and may be accessible within the electronic device 500.

The electronic device 500 may further include additional removable/non-removable, volatile/non-volatile storage media. Although not illustrated in FIG. 5, a disk drive for reading from or writing on a removable, non-volatile disk (e.g., a ‘floppy disk’) and an optical disk drive for reading from or writing to a removable, non-volatile optical disk may be provided. In these embodiments, each drive may be connected to a bus (not illustrated) by one or more data media interfaces. The memory 520 may include a computer program product 525 having one or more program modules that are configured to perform various methods or actions of various embodiments of the present disclosure.

The communication unit 540 implements communication with other electronic devices via a communication medium. Additionally, the functions of the components of the electronic device 500 may be implemented as a single computing cluster or a plurality of computing machines that are capable of communicating over a communication connection. Thus, the electronic device 500 may use logical connections to one or more other servers, networked personal computers (PCs), or a further network node to operate in a networked environment.

The input device 550 may be one or more input devices, such as a mouse, a keyboard, a tracking ball, and the like. The output device 560 may be one or more output devices, such as a monitor, a speaker, a printer, and the like. The electronic device 500 may also communicate, as desired, via the communication unit 540, with one or more external devices (not illustrated), external devices such as storage devices, display devices, etc., with one or more devices that enable a user to interact with the electronic device 500, or with any device that enables the electronic device 500 to communicate with one or more other electronic devices (e.g., a network card, modem, etc.) to communicate. Such communication may be performed via an input/output (I/O) interface (not illustrated).

According to an example implementation of the present disclosure, there is provided a computer-readable storage medium having computer-executable instructions stored thereon, where the computer-executable instructions are performed by a processor to implement the method described above. According to an example implementation of the present disclosure, there is also provided a computer program product, the computer program product being tangibly stored on a non-transient computer-readable medium and including computer-executable instructions, where the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for media asset generation, comprising:
presenting a media asset generation interface in response to a predetermined operation received in a media editing interface, the media asset generation interface comprising a canvas component;
presenting, in the canvas component, a graphical content corresponding to a first interaction operation in response to the first interaction operation received via the canvas component;
presenting, in a preview component of the media editing interface, a first media asset generated based on the graphical content; and
adding, in response to a second interaction operation received via the media asset generation interface, a target media asset determined based on the first media asset to the media editing interface.

2. The method of claim 1, further comprising:
obtaining first input information; and
presenting, in the preview component, the target media asset determined based on the first input information and the first media asset.

3. The method of claim 2, wherein obtaining the first input information via the preview component comprises:
obtaining a first description text via a first input control in the preview component, wherein the target media asset comprises a second media asset generated by a generation model based on the first description text and the first media asset.

4. The method of claim 2, wherein obtaining the first input information via the preview component comprises:
receiving a selection of at least one first candidate item in a first set of candidate items presented in the preview component, wherein the target media asset comprises a third media asset generated by a generation model based on the first media asset and a predetermined prompt corresponding to the at least one first candidate item.

5. The method of claim 1, wherein presenting, in the preview component of the media editing interface, the first media asset generated based on the graphical content comprises:
obtaining second input information; and
presenting, in the preview component, the first media asset determined based on the second input information and the graphical content.

6. The method of claim 5, wherein obtaining the second input information via the canvas component comprises:
obtaining a second description text via a second input control in the canvas component.

7. The method of claim 5, wherein obtaining the second input information via the canvas component comprises:
receiving a selection of at least one of the second set of candidate items presented in the canvas component.

8. The method of claim 1, further comprising:
receiving, via the preview component, an editing operation for the first media asset to determine the target media asset.

9. The method of claim 1, wherein the media editing interface comprises a media editing panel and a media asset selection panel, the media asset selection panel comprises a media asset generation entry, and presenting the media asset generation interface in response to the predetermined operation received in the media editing interface comprises:
presenting the media asset generation interface in response to the media asset generation entry being selected.

10. The method of claim 9, wherein adding the target media asset determined based on the first media asset to the media editing interface comprises:
adding, in response to the second interaction operation received via the media asset generation interface, the target media asset to at least one of the media editing panel or the media asset selection panel in the media editing interface.

11. An electronic device, comprising:
at least one processor; and
at least one memory coupled to the at least one processor and storing instructions for execution by the at least one processor, the instructions, when executed by the at least one processor, causing the electronic device to perform acts comprising:
presenting a media asset generation interface in response to a predetermined operation received in a media editing interface, the media asset generation interface comprising a canvas component;
presenting, in the canvas component, a graphical content corresponding to a first interaction operation in response to the first interaction operation received via the canvas component;
presenting, in a preview component of the media editing interface, a first media asset generated based on the graphical content; and
adding, in response to a second interaction operation received via the media asset generation interface, a target media asset determined based on the first media asset to the media editing interface.

12. The electronic device of claim 11, further comprising:
obtaining first input information; and
presenting, in the preview component, the target media asset determined based on the first input information and the first media asset.

13. The electronic device of claim 12, wherein obtaining the first input information via the preview component comprises:
obtaining a first description text via a first input control in the preview component, wherein the target media asset comprises a second media asset generated by a generation model based on the first description text and the first media asset.

14. The electronic device of claim 12, wherein obtaining the first input information via the preview component comprises:
receiving a selection of at least one first candidate item in a first set of candidate items presented in the preview component, wherein the target media asset comprises a third media asset generated by a generation model based on the first media asset and a predetermined prompt corresponding to the at least one first candidate item.

15. The electronic device of claim 11, wherein presenting, in the preview component of the media editing interface, the first media asset generated based on the graphical content comprises:
obtaining second input information; and
presenting, in the preview component, the first media asset determined based on the second input information and the graphical content.

16. The electronic device of claim 15, wherein obtaining the second input information via the canvas component comprises:
obtaining a second description text via a second input control in the canvas component.

17. The electronic device of claim 15, wherein obtaining the second input information via the canvas component comprises:
receiving a selection of at least one of the second set of candidate items presented in the canvas component.

18. The electronic device of claim 11, wherein the acts further comprises:
receiving, via the preview component, an editing operation for the first media asset to determine the target media asset.

19. The electronic device of claim 11, wherein the media editing interface comprises a media editing panel and a media asset selection panel, the media asset selection panel comprises a media asset generation entry, and presenting the media asset generation interface in response to the predetermined operation received in the media editing interface comprises:
presenting the media asset generation interface in response to the media asset generation entry being selected.

20. A non-transitory computer-readable storage medium having a computer program stored thereon, the computer program being executable by a processor to perform acts comprising:
presenting a media asset generation interface in response to a predetermined operation received in a media editing interface, the media asset generation interface comprising a canvas component;
presenting, in the canvas component, a graphical content corresponding to a first interaction operation in response to the first interaction operation received via the canvas component;
presenting, in a preview component of the media editing interface, a first media asset generated based on the graphical content; and
adding, in response to a second interaction operation received via the media asset generation interface, a target media asset determined based on the first media asset to the media editing interface.
